(19) United States
(12) Patent Application Publication
(10) Pub. No.: US 2014/0265012 A1
(43) Pub. Date: Sep. 18, 2014

(54) OVEN FOR SHAPING EXTRUDED MATERIAL

(71) Applicant: AJAX-UNITED PATTERNS & MOLDS, INC., Union City, CA (US)

(72) Inventor: Hamid R. Ghalambor, Newport Beach, CA (US)

(73) Assignee: Ajax-United Patterns & Molds, Inc., Union City, CA (US)

(21) Appl. No.: 13/797,329

(22) Filed: Mar. 12, 2013

(51) Int. Cl. B29C 47/88

(52) U.S. Cl. CPC B29C 47/8805
USPC 264/210.1; 425/378.1

(57) ABSTRACT

A oven and oven system are provided to shape materials. In some embodiments, material is received from an extruder by inlet of an oven. The oven may include segments that are serially engaged to form a shape mold, as well as a heating element that heats the material, such that the material is concurrently heated and shaped. The material may be shaped into, for example, a ring by cutting and welding the ends of the material after removing it from the shape mold.

The present disclosure relates to an oven for shaping materials, and more particularly relates to an oven with multiple segments for shaping objects such as rings from a thermoplastic or other suitable material.

### SUMMARY

An oven and oven system are provided for heating and shaping materials. In some embodiments, material is received from an extruder by an inlet. The material is received by a plurality of oven segments which form a shape mold. The extrusion process may generate a shaping force that shapes the material as it moves through the shape mold. A heating element may heat the material as it is shaped. In some embodiments, the oven segments may be added or removed to change the size of the shape mold. In some embodiments, the oven segments are coupled to a support structure.

### BRIEF DESCRIPTION OF THE FIGURES

The above and other features of the present disclosure, its nature and various advantages will be more apparent upon consideration of the following detailed description, taken in conjunction with the accompanying drawings in which:

FIG. 1 is a schematic illustration of an oven system in accordance with some embodiments of the present disclosure;

FIG. 2 is a perspective view of an oven in accordance with some embodiments of the present disclosure;

FIG. 3 is a plan view of an oven with diameter d₁ in accordance with some embodiments of the present disclosure;

FIG. 4 is a plan view of an oven with diameter d₂ in accordance with some embodiments of the present disclosure; and

FIG. 5 is a flow diagram including illustrative steps for heating and shaping materials in accordance with some embodiments of the present disclosure.

### DETAILED DESCRIPTION OF THE FIGURES

The present disclosure is directed towards shaping and forming of materials. In some embodiments, an oven is used to concurrently heat and shape extruded materials such as thermoplastics into desired shapes such as rings. An extruder may produce a continuous extrusion of material with a desired cross-section. An oven inlet may receive material from the extruder such that the extrusion force moves the material into the oven. The oven may be arranged such that it bends the material into a desired shape, while substantially maintaining a desired cross-sectional geometry. A shaping force may be generated by the force from the extruder. The oven may include a heating element, such that the material is concurrently heated and shaped. In some embodiments, the shaped material may be cut and welded to form a continuous shape such as a toroid. As used herein, a toroid is a 3-dimensional object defined by rotating a shape about an axis. For example, the rotation of a circle around an axis forms a doughnut shape. In another example, the rotation of a square around an axis forms a ring with a square cross-section. It will be understood that any suitable cross-sectional shape, including complex shapes, may be used.

FIG. 1 is a schematic illustration of oven system 100 in accordance with some embodiments of the present disclosure.

Oven system 100 includes extruder 104 with feed supply 102 and die 106. Extruder 104 may be any suitable system for producing a substantially longitudinally continuous form. Extruder 104 may extrude polymers, metals, glasses, ceramics, clays, any other suitable material, or any combination thereof. Feed supply 102 may include any suitable inlet for material to be formed by the extruder. For example, feed supply 102 may be a hopper that holds thermoplastic resin. Thermoplastics may include polymers that significantly soften before melting when heated, and return to a solid state upon cooling. In another example, feed supply 102 may be an inlet for metal billets or other shapes, any other suitable feedstock for extrusion, or any combination thereof. Feed supply 102 may include room temperature materials, melted materials, heated solid materials, liquids, material at any other suitable temperature, or any combination thereof. Extruder 104 may include an extrusion screw, piston, ram, any other suitable apparatus to generate a force on the material, or any combination thereof. In some embodiments, extruder 104 heats the material from feed supply 102. In some embodiments, extruder 104 applies a force to push material from feed supply 102 through die 106. Die 106 may include a solid surface with an opening that corresponds to the desired cross-section of the extruded material. For example, a die with a round opening would result in a round bar extrusion. In another example, a die with a square opening would result in a square bar extrusion. In some embodiments, die 106 may produce circular cross-sectional diameters up to 60 mm and/or other shapes within a suitably equivalent size range such as a rectangular cross-section with a 60 millimeter diagonal measurement. It will be understood that any suitable cross-section of any suitable size may be generated by the extruder, including hollow shapes (e.g., pipes). In some embodiments, the extruder may heat and/or melt the material in the process of extrusion. In some embodiments, the temperature of extruded material may be altered at the outlet of die 106 using air, water, heat conducting rollers, any other suitable temperature altering technique, or any combination thereof.

In an example, feed supply 102 may contain thermoplastic resin pellets. Extruder 104 contains a heater and an extrusion screw that melt the resin and push it through die 106 containing a round opening, such that a substantially continuous round thermoplastic bar is formed. The temperature throughout the extruder may be controlled such that the bar is hot but not melted upon exiting die 106. For example, the thermoplastic may initially be melted by the extruder, and then cooled to slightly below the melting temperature before reaching the die. In another example, feed supply 102 may receive a heated aluminum billet that is pushed using a hydraulic ram through die 106.

Extruded material 110 exits from die 106 of extruder 104. For example, extruded material 110 may be a round extrusion of a thermoplastic such as acrylonitrile butadiene styrene (ABS), Poly(methyl methacrylate) (PMMA), polycarbonate (PC), polyethylene terephthalate (PET), polypropylene (PP), polystyrene (PS), polyvinyl acetate (PVA), polyvinyl chloride (PVC), nylon, any other suitable thermoplastic or thermoplastic blend, or any combination thereof. In some embodiments, extruded material 110 is warm from the extrusion process of extruder 104. In some embodiments, the temperature of extruded material 104 may be increased or reduced using any suitable technique before reaching inlet 112. In some embodiments, material 110 may receive any suitable surface treatment, heat treatment, coating, annealing, any other suitable process, or any combination thereof, before reaching inlet 112.

Oven 108 may include inlet 112, rollers 114, and heating element 120. Inlet 112 receives extruded material 110 from extruder 104. In some embodiments, the motion of the material out of the extruder, as indicated in the arrow of FIG. 1, moves the material into and through oven 108. In some embodiments, motion of the material from extruder 104 generates a shaping force (e.g., a bending force) that shapes the material as it moves through oven 108.

It will be understood that inlet 112 may be coupled to die 106 in any suitable manner. For example, die 106 may be directly connected to the inlet using, for example, a flange or other suitable coupling. In another example, material 110 may travel a particular distance from die 106 to inlet 112. The material may be heated, cooled, coated, or otherwise altered while moving from die 106 to inlet 112. In another example, the material may pass through an channel between die 106 and inlet 112, where the channel is a temperature insulated channel, an airtight channel, a vacuum channel, any other suitable channel or any combination thereof. In some embodiments, the material may be physically supported between die 106 and inlet 112 using, for example, rollers, a conveyer belt, any other suitable support, or any combination thereof.

In some embodiments, the interior of oven 108 includes elements to reduce friction associated with shaping material 110 in the oven. In the illustrated embodiment, oven 108 includes rollers such as roller 114. In an example, roller 114 is a stainless steel cylindrical roller that spins on an axis orthogonal to the motion of the material through oven 108. In another example, the interior of oven 108 may include a substantially smooth surface against which material 110 is in contact. In some embodiments, rollers and/or surfaces in contact with the material are coated with a low-friction material such as polytetrafluoroethylene (PTFE). It will be understood that the use of rollers and coated surfaces are merely exemplary and that oven 108 may use any suitable technique to reduce friction as a bending force is applied to material 110. It will also be understood that the particular arrangement of rollers shown in FIG. 1 is merely exemplary. For example, the system may include more rollers such that they form a nearly continuous surface along the walls of oven 108. In another example, rollers may be used in one portion of the oven, while a smooth surface is used in anther portion. In some embodiments, one or more rollers are driven by a motor. For example, a roller may spin under power, which may produce a force that moves material 110 through oven 108.

In some embodiments, the leading edge 116 of material 110 moves through oven 108 to outlet 118. In some embodiments, the oven may include a more complete circle than the circle illustrated in FIG. 1. Material 110 may be cut at inlet 112, at outlet 118, at any other suitable location, or any combination thereof. In some embodiments, the ends of the material may be welded or otherwise joined to form a continuous shape. In an example, the shaped material may be removed from the oven, allowed to cool, and the end may be joined using a laser welding process.

In some embodiments, heating element 120 heats material 110 inside of oven 108. In some embodiments, heating elements such as heating element 120 may be positioned to heat some or all of oven 108. In some embodiments, heating element 120 may be embedded into oven 108 (i.e., so as to form a part of oven 108), may be detachable from oven 108, may control temperature within a controlled environment into which oven 108 may be placed, may be configured in any other suitable arrangement, or any combination thereof. Heating element 120 may include resistance heating, infrared heating, gas fired heaters, hot air heaters, induction heater, microwave heaters, any other suitable heating technique, or any combination thereof. In some embodiments, heating element 120 may heat material 110, may heat oven 108, may heat any other suitable elements in order to heat material 110, or any combination thereof. Heating may include conduction, radiant, convention, dipole, any other suitable heating technique, or any combination thereof. In some embodiments, heating element 120 may maintain the temperature of material 110 in a range that is desirable for bending. For example, for a thermoplastic, heating element 120 may maintain the temperature of the material between the glass transition temperature (e.g., the temperature above which a thermoplastic is easily deformed) and the melting temperature of the material. For example, the temperature may be maintained at a point between 150 degrees and 350 degrees Celsius. It will be understood that any suitable operating temperature range may be used. For example, metal extrusion and bending may involve higher temperatures.

In some embodiments, a temperature controlled environment such as a furnace may include one or more heating elements 120 in order to heat the environment. The temperature controlled environment may include materials with thermally insulating properties, doors, windows, circulating fans, any other suitable components, or any combination thereof. The temperature controlled environment may be configured such that some or all of oven 108 may be placed inside in order to heat oven 108 and material 110. For example, oven 108 may be located inside the temperature controlled environment with inlet 112 coupled to an opening through a wall, in order to allow material 110 to enter oven 108.

In some embodiments, control system 122 may provide control to extruder 104, die 106, rollers 114, heating element 120, any other suitable elements of oven system 100, or any combination thereof. Control system 122 may include any suitable hardware, software, or combinations thereof. Control system 122 may include sensors coupled to one or more elements of oven system 100. Sensors may include, for example, thermocouples to determine a temperature, roller speed sensors to determine motion of the material on roller 114, position sensors to determine the position of material within oven 108, any other suitable sensors, or any combination thereof. Sensors may also include extruder sensors to determine the temperature of material at 110 at one or more positions within extruder 104 or at any other point, extrusion rate, contents of feed supply 102, other suitable extrusion parameters, or any combination thereof. Control system 122 may include one or more processors coupled to the sensors to process signals from the sensors. In some embodiments, control system 122 may include a user interface capable of receiving user input. In an example, control system 122 may include one or more programmable parameters that are set based on user input. In some embodiments, programmable parameters correspond to desired parameters for the sensors coupled to control system 122. For example, user system 122 may receive user input indicating a desired temperature for oven 108. Control system 122 may set an amount of power delivered to heating element 120 and may adjust that power based on feedback from one or more thermocouples in order to maintain the desired temperature. Control system 122 may include any suitable user interface including, for example, a keyboard, mouse, monitor, touchscreen, printer, buttons, dials, any other suitable input or output device, or any combination thereof. In some embodiments, control system 122 may include a graphical user interface. In another example, control system 122 may adjust the feed rate of material 110 out of extruder 104 and/or the power supplied to powered rollers to adjust the speed of material through oven 108 based on a programmed desired rate. In some embodiments, one or more sensors may provide a feedback control loop. In some embodiments, control system 122 may function as a non-feedback controller. It will be understood that feedback control, non-feedback control, and any combination thereof may be used by oven system 100.

FIG. 2 is a perspective view of oven 200 in accordance with some embodiments of the present disclosure. Oven 200 includes inlet 202, outlet 210, oven segments 204, 206, and 208, support structure 214, and base 212. In some embodiments, inlet 202 corresponds to inlet 112 of FIG. 1. In some embodiments, outlet 210 corresponds to outlet 118 of FIG. 1. In some embodiments, oven segments 204, 206, and 208 correspond to segments of oven 108 of FIG. 1. Heating elements, not shown in FIG. 2, may be configured to heat the oven segments or corresponding material of oven 200 as described for heating element 120 of FIG. 1. For example, heating elements may be embedded in oven segments such as oven segments 204, 206, and 208 so as to form a part of oven 200.

In some embodiments, outlet 210 includes cutout 216. Cutout 216 may provide a straight line path for material to enter inlet 202 from an extruder. For example, cutout 216 may prevent oven 200 from physically blocking a path to inlet 202, while allowing oven 200 to have a configuration that is nearly a complete circle. In some embodiments, oven 200 may form a complete circle and may not include inlet 212 and outlet 210. In the embodiment, an oven segment may include an opening, for example in the outer wall of the oven, to allow material from an extruder to enter oven 200. It will be understood that the aforementioned is merely exemplary and that any suitable technique to introduce material to oven 200 from an extruder may be used.

In some embodiments, oven 200 may include a number of oven segments such as oven segments 204, 206, and 208. The number of oven segments may be changed, thus changing the size of the oven, as will be described further in relation to FIG. 3 below. In some embodiments, the ends of an oven segment may be configured such that an end of one oven segment engages with the adjacent oven segment, such that the oven segments are serially engaged to form a shape mold such as oven 108 of FIG. 1. For example, oven segments 204, 206, and/or 208 may include extensions that overlap a portion of an adjacent oven segment. In some embodiments, the overlapping may be used to form a shape mold, where the overlapping portions fill in gaps between oven segments. The overlapping portions may fix the size and shape of the shape mold. Additionally or alternatively, the shape mold may be formed by the oven segments latching or locking in place, for example by locking to support structure 214. Oven segments including, for example, oven segments 204, 206, and 208, may form a circular shape mold (as shown), an elliptical shape mold, a curved shape mold, or any other suitable shape mold. In some embodiments, the shape mold may be a substantially circular mold with a diameter in the range of 10 inches to 35 inches. In some embodiments, a mold with a 10 inch diameter is formed using the minimum possible number of oven segments, and a mold with a 35 inch diameter is formed using the maximum possible number of oven segments. In some embodiments, this may be limited by the curvature of each individual oven segments, the support structure, any other suitable parameter, or any combination thereof. In some embodiments, the shape mold may be a substantially circular mold with a diameter in the range of 25 inches to 75 inches. In some embodiments, this range may represent the minimum and maximum number of oven segments for oven segments of a different configuration (e.g., a difference curvature) than those that form the 10 inch to 35 inch range.

In some embodiments, the oven segments are coupled to support structure 214. As illustrated, support structure 214 may include arms or spokes, though it will be understood that support structure may include any suitable structure configured to hold the oven segments in a desired position. For example, support structure 214 may alternatively include a solid disk or a table. Support structure 214 may allow the size and shape of the coupled oven segments to be reconfigured. For example, the oven may be reconfigured to form a smaller circular diameter by moving segments inwards towards the center on support structure 214. In some embodiments, support structure 214 is coupled to base 212. In some embodiments, support structure 214 may rotate axially on base 212. For example, rotation may be used in the process of removing formed material from the shape mold. In some embodiments, a motor may rotate support structure 214. In some embodiments, support structure 212 and base 210 may adjust and/or reconfigured to accommodate changes in an attached extruder. In some embodiments, overlapping portions of the segments may allow the oven size and shape to be altered without changing the number of oven segments. For example, a change in the diameter of a circular shape mold may be accommodated by more or less of the overlapping portions being exposed. In another example, the extensions may be a flexible material, bellows, other adjustable connector, or any combination thereof, that permit a suitable amount of change in alignment and distance between successive oven segments such as between oven segment 204 and oven segment 206.

FIG. 3 is a plan view of an oven with diameter d: in accordance with some embodiments of the present disclosure. The oven includes oven segments 302, 304, and 306, and support structure 312. In some embodiments, the oven includes inlet 308 and outlet 310 corresponding to inlet 112 of FIG. 1 and outlet 118 of FIG. 1, respectively. In the illustrated example, the oven is configured in a circular arrangement with diameter d₁. In some embodiments, one or more of the oven segments may be removed, and the position of the oven segments on support structure 312 rearranged, to reconfigure the shape mold to have a smaller diameter, as shown below in FIG. 4. For example, the shape mold with diameter d₁ has 19 segments, and the shape mold of FIG. 4 with diameter d₂ has 15 segments. It will be understood that in some embodiments, the size of the oven may be altered without changing the number of oven segments.

FIG. 4 is a plan view of an oven with diameter d₂ in accordance with some embodiments of the present disclosure. The oven includes oven segments 402 and 404, and support structure 406. As described above, several of the oven segments have been removed from the oven and the segments rearranged such that a relatively smaller diameter shape mold with diameter d₂ is formed relative to d₁. In some embodiments, reconfiguring the size and shape of the oven may be performed manually, automatically, or any combination thereof.

FIG. 5 shows flow diagram 500 including illustrative steps for heating and shaping materials in accordance with some embodiments of the present disclosure.

Step 502 includes extruding a material. In some embodiments, material is extruded as described for extruder 104 of FIG. 1. For example, a thermoplastic may be extruded with a circular cross section by melting plastic resin and forcing it through a die. As described above, the material may have any suitable cross-section such as a circle, square, rectangle, oval, “I” shape, “T” shape, “L” shape, any other suitable shape, or any combination thereof. Cross sections may be solid or include hollow sections, for example, in hollow tubing. Complex extrusion cross-sections may include, for example, ridges, channels, any other suitable elements, or any combination thereof.

Step 504 includes receiving the material extruded in step 504. In some embodiments, material may be received by an oven that forms a shape mold at an inlet such as inlet 112 of FIG. 1 and inlet 202 of FIG. 2. In some embodiments, the material is received directly from the extruder, such that the force extruding the material through the die also generates a shaping force in the shape mold.

Step 506 includes heating the material. In some embodiments, material received in step 504, such as material 110 of FIG. 1, is heated inside of the oven. In some embodiments, one or more heating elements such as heating element 120 of FIG. 1 may be coupled to the oven. For example, heating elements may substantially cover all of the oven segments. In some embodiments, a shape mold may be substantially located inside of a controlled temperature environment. In some embodiments, heating includes maintaining a desired temperature for bending and shaping the material. For example, the material may be maintained at a temperature that is lower than the melting temperature but high enough that stresses are reduced. In some embodiments, heating the material also includes annealing and controlled cooling processes.

Step 508 includes shaping the material. In some embodiments, the material received in step 504, such as material 110 of FIG. 1, is shaped using the shape mold formed by the oven segments. In some embodiments, the force generated by the extruder generates a shaping force in the shape mold. For example, the extruder may push the material through the die and into the oven, where the material contacts a roller on the outside wall. The extruder may continue to push the material as it bends to conform to the wall of the oven. In some embodiments, shaping includes using rollers and/or smooth surfaces inside of the oven segments, as described above.

In some embodiments, steps 506 and 508 are performed concurrently. For example, the oven segments may be heated when the material is first received by the oven. The oven may continue to be heated until a desired amount of material is introduced to the oven, at which point the heating may be reduced or stopped. In another example, heating levels may be adjusted to anneal material following shaping. In another example, heating may remain constant as material is added to the oven and removed in step 510 below.

Step 510 includes cutting the material. In some embodiments, the extruded material may be cut after a desired amount of material has been received by the oven. For example, the amount of material to form a complete ring may be received, following which one or both ends of the mold may be cut. Cutting may include laser cutting, waterjet cutting, mechanical cutting, melting, any other suitable cutting technique, or any combination thereof. In some embodiments, ends may be cut such that they form matched surfaces for welding in step 514, as described below.

Step 512 includes removing the material from the oven. In some embodiments, the temperature of the material is reduced inside of the oven before removal. In some embodiments, the oven opens or separates in order to remove the material. For example, the top of the oven may lift off in order to allow the material to be lifted out vertically. In another example, the material may be removed after cutting by removing it from the inlet. In another example, the material may be removed after cutting by continuing to move it through the oven to the outlet, for example using powered rollers. In some embodiments, a motor may rotate a support structure such as support structure 214 of FIG. 2 to assist in removing the material.

Step 514 includes welding the material. In some embodiments, the ends of the material may be joined. For example, the material may be shaped into a circular ring, and may be welded such that a continuous shape, for example, any suitable toroidal shape as described above, is formed. Shapes produced by welding may include, for example, o-rings, washers, pipe seals, any other suitable shape, or any combination thereof. Welding may include laser welding, arc welding, chemical welding, friction welding, hot air welding, high frequency welding, any other suitable welding technique, or any combination thereof.

It will be understood that the steps above are exemplary and that in some embodiments, steps may be added, removed, omitted, repeated, reordered, modified in any other suitable way, or any combination thereof. For example, the material may be welded before it is removed. In another example, the material may be cut again after removing. In another example, the material may not be welded. For example, a split o-ring may be produced by shaping and cutting material but not welding it.

The foregoing is merely illustrative of the principles of this disclosure and various modifications may be made by those skilled in the art without departing from the scope of this disclosure. The above described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed:

1. An oven comprising:
an inlet configured to receive material from an extruder;
a plurality of segments coupled to the inlet, wherein the segments are engaged with one another serially to form a shape mold; and
a heating element that operates on the shape mold to heat the material.

2. The oven of claim 1, wherein the material is a thermoplastic.

3. The oven of claim 1, wherein the extruder is configured to generate a shaping force in the shape mold.

4. The oven of claim 1, wherein the shape mold is a substantially circular shape.

5. The oven of claim 4, wherein the shape mold is adjustable to have a diameter in the range of 10 inches to 35 inches.

6. The oven of claim 4, wherein the shape mold is adjustable to have a diameter in the range of 25 inches to 75 inches.

7. The oven of claim 1, wherein the segments are configured such that segments can be added or removed to change the size of the shape mold.

8. The oven of claim 1, wherein at least one of the oven segments comprises a low friction surface that is arranged to contact the material.

9. The oven of claim 8, wherein the surface comprises a friction-reducing polymer.

10. The oven of claim 1, wherein at least one of the oven segments comprises rollers.

11. The oven of claim 10, wherein the rollers are configured to be driven by a motor.

12. The oven of claim 1, wherein the heating element is configured to heat the material to a temperature in the range of 150 degrees Celsius to 350 degrees Celsius.

13. The oven of claim 1, wherein the oven segments comprise extensions, and wherein the oven segments are configured to be arranged such that an extension of one of the segments overlaps a portion of an adjacent segment.

14. The oven of claim 1, wherein the inlet is configured to receive material with a cross-sectional dimension up to 60 millimeters.

15. An oven system, comprising:
a support structure;
an extruder;
a plurality of segments coupled to the support structure that are arranged to form a shape mold, the shape mold coupled to the extruder; and
a heating element configured to heat a material in the shape mold.

16. The oven system of claim 15, further comprising a motor configured to rotate the support structure.

17. The oven system of claim 15, wherein the shape mold is a substantially circular shape.

18. The oven system of claim 15, wherein the segments are configured such that segments can be added or removed to change the size of the shape mold.

19. The oven system of claim 15, wherein the heating element is configured to heat the material to a temperature in the range of 150 degrees Celsius to 350 degrees Celsius.

20. The oven system of claim 15, wherein the oven segments comprise extensions, and wherein the oven segments are configured to be arranged such that an extension of one of the segments overlaps a portion of an adjacent segment.

21. The oven system of claim 15, further comprising a controller coupled to the heating element and configured to control the temperature produced by the heating element.

22. The oven system of claim 15, further comprising an inlet coupled to the shape mold and to the extruder, the inlet configured to pass the material from the extruder into the shape mold.

23. A method comprising:
receiving, into a shape mold comprising a plurality of segments serially engaged with one another, a material from an extruder;
heating, using a heating element, the material inside the shape mold; and
shaping the material inside the shape mold during the heating.

24. The method of claim 23 further comprising causing the material to be pushed into the shape mold using a force generated by the extruder.
